(19) United States
(12) Patent Application Publication
(10) Pub. No.: US 2015/0161566 A1
(43) Pub. Date: Jun. 11, 2015

(54) WORKFORCE PLANNING AND ANALYTICS

(71) Applicant: Danqing CAI, Singapore (SG)

(72) Inventor: Danqing CAI, Singapore (SG)

(21) Appl. No.: 14/098,549

(22) Filed: Dec. 6, 2013

(51) Int. Cl. G06Q 10/10

(52) U.S. Cl. CPC G06Q 10/1053

(57) ABSTRACT

Described herein is a framework to facilitate workforce planning and analytics. In accordance with one aspect, profile data of at least one job candidate and job data of at least one job opening are received from multiple data sources. The framework may automatically determine a match score between the job candidate and the job opening. Analytics may be performed based at least in part on the match score, the profile data and the job data. Results of the analytics may then be presented.

### TECHNICAL FIELD

The present disclosure relates generally to computer systems, and more specifically, to a framework for workforce planning and analytics.

### BACKGROUND

Talent acquisition and workforce management are becoming more and more important in today's economic environment. Due to rapid changes in technological and economic trends, however, municipal governments are facing the problem of increasing mismatches between the job market demand and the available talent resources. For example, in June 2013, Singapore's total unemployment rate was 4% higher than a year ago, even though the overall number of job openings has increased by 9% over the same period of time. This indicates that there was a larger group of job seekers who most likely did not have the right skills as required by the newly created jobs. Therefore, there is a need to discover the root cause of such mismatches and create actionable interventions for better city level workforce planning and development.

In private companies and public sectors (e.g., healthcare, transportation, safety, etc.), discovering such root cause and intervention are usually performed through workforce planning and analytics. Workforce planning is a systematic process that aims to place the right people in the right positions at the right times. It has not been adapted at a city municipality's level to tackle the issue of unemployment of local residents, mainly due to the lack of data support and controllable interventions, as compared to a single corporation entity.

The current practice of workforce management at the city municipality level is to match the explicit needs of individual workers, employers and training agencies through various activities and programs. Such activities and programs typically face the following challenges: (1) limited participation by both individuals and employers; (2) professional channels serving similar purposes; and (3) lack of transparency in the effectiveness of funds provided. The existing programs and activities do not support a sustainable growth and upgrade of the city workforce on a strategically proactive level.

### SUMMARY

A framework for facilitating workforce planning and analytics is described herein. In accordance with one aspect, profile data of at least one job candidate and job data of at least one job opening are received from multiple data sources. The framework may automatically determine a match score between the job candidate and the job opening. Analytics may be performed based at least in part on the match score, the profile data and the job data. Results of the analytics may then be presented.

In accordance with another aspect, the framework automatically acquires profile data of multiple job candidates, job data of multiple job openings and event data. The framework may automatically generate an outlook report based on the event data, wherein the outlook report predicts a set of skills that are likely to be in demand by employers in future. The framework may further generate a gap report based on the profile data, the job data and the outlook report. The gap report may identify one or more skills from the predicted set of skills that are least fulfilled by the job candidates.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary architecture;

FIG. 2 shows exemplary components of a predictive workforce planning and analytics engine;

FIG. 3 shows an exemplary method of predictive workforce planning and analytics;

FIG. 4 shows an exemplary method of deriving skill inferences;

FIG. 5a shows an exemplary dashboard presented by a client application at a client device;

FIG. 5b shows another exemplary dashboard presented by a client application at a client device;

FIG. 6 shows yet another exemplary dashboard presented by a client application at a client device; and

FIG. 7 shows an exemplary report presented by a client application at a client device.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework for facilitating workforce planning and analytics is described herein. In some implementations, the framework combines information from different data sources to perform predictive workforce analytics. Exemplary data sources include, for example, individual profiles from professional social networks, news feed of economic outlook, technological trends, business environment, company strategies, published openings from job portals, and so forth. The predictive workforce analytics model may generate: (1) analyses of supply, demand, gap and/or risk for municipal government and local employers; (2) root cause suggestions and intervention effectiveness analyses for municipal government; and/or (3) outlook & competitiveness analyses for individuals.

There are many benefits and advantages presented by the present framework. For instance, it may provide the municipal government and local employers with more clarity in their knowledge of the local workforce. With such knowledge, they may be able to devise effective interventions to better balance the demand and supply of human capital and to influence local residents who have already joined or will be joining the workforce. For individual users, this framework may provide personalized insight of their individual skill sets, competency level, and development needs. It may empower them to make better decisions regarding their own education and career development. The expansion of economy is demanding more knowledge workers with substantial levels of training and education. The present framework may provide relevant stakeholders with the necessary insight to stay agile and competitive.

It should be appreciated that the framework described herein may be implemented as a method, a computer-controlled apparatus, a computer process, a computing system, or as an article of manufacture such as a computer-usable medium. These and various other features will be apparent from the following description.

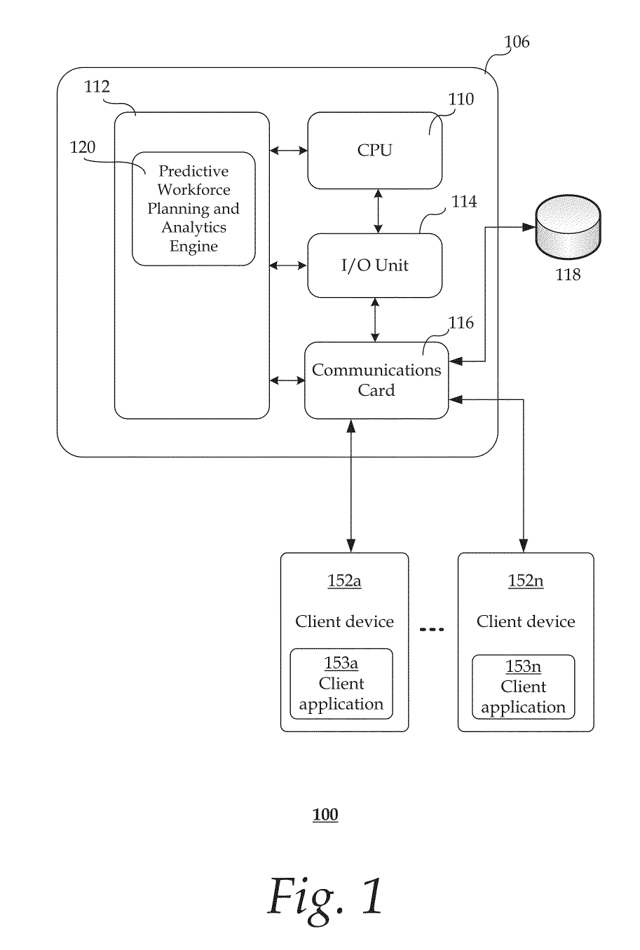

FIG. 1 is a block diagram illustrating an exemplary architecture 100 in accordance with one aspect of the present framework. Generally, exemplary architecture 100 may include a computer system 106, a data repository 118 and client devices 152a-n.

Computer system 106 can be any type of computing device capable of responding to and executing instructions in a defined manner, such as a workstation, a server, a portable laptop computer, another portable device, a mini-computer, a mainframe computer, a storage system, a dedicated digital appliance, a device, a component, other equipment, or some combination of these. Computer system 106 may include a central processing unit (CPU) 110, an input/output (I/O) unit 114, a memory module 112 and a communications card or device 116 (e.g., modem and/or network adapter) for exchanging data with a network (e.g., local area network (LAN), wide area network (WAN), Internet, etc.). It should be appreciated that the different components and sub-components of the computer system 106 may be located or executed on different machines or systems. For example, a component may be executed on many computer systems connected via the network at the same time (i.e., cloud computing).

Computer system 106 may further be communicatively coupled to one or multiple data repositories 118. A data repository 118 may be, for example, any database (e.g., relational database, in-memory database, etc.), an entity (e.g., set of related records), or a data set included in a database. In some implementations, data repository 118 serves to store data of profiles of individual candidates or job seekers (e.g., names, user id, qualifications, skill descriptions, alias, years of experience, rankings, demographic information, etc.), news articles or publications related to economic outlook, technological trend, business environment, government directives and company strategies, published job openings, and so forth.

In some implementations, data repository 118 is implemented as an in-memory database. In-memory databases allow seamless access to and propagation of high volumes of data in real time. Parallel processing may further be achieved by using a multicore processor in conjunction with the in-memory database 118. The in-memory database 118 is a database management system that relies primarily on a system's main memory for efficient computer data storage. More particularly, the data in the in-memory database resides in volatile memory and is not persistently stored on a hard drive, thereby allowing the data to be instantly accessed and scanned at a speed of several megabytes per millisecond.

Computer system 106 may act as a server and operate in a networked environment using logical connections to one or more client devices 152a-n. Each client device 152 may be associated with one or more individual users, and serves as an interface to send and receive information from computer system 106. In some implementations, client device 152 is a mobile device that includes, but is not limited to, a smart phone, a tablet computer, a handheld laptop, a cellular device, a mobile phone, a gaming device, a portable digital assistant (PDA), a portable media player, a wireless device, a data browsing device, and so forth. Client device 152 may also be a non-mobile computing device, such as a workstation, a server, a mini-computer, a mainframe computer, a storage system, a dedicated digital appliance, a device, a component, other equipment, or some combination of these. Client device 152 includes components similar to a computer system capable of responding to and executing instructions in a defined manner, such as an input device for receiving user input (e.g., touch screen, keypad, etc.), an output device for displaying a graphical user interface, a communications card, a memory for storing a client application 153, a processor for executing the client application 153, and so forth.

Client application 153 may include, for example, a mobile application (or app). In some implementations, client application 153 presents one or more dashboards (or graphical user interfaces) to access one or more workforce-related (or job-related) services, including services provided by predictive workforce planning and analytics engine 120. In some implementations, client application 153 captures, manages and/or displays information related to the profile of the individual candidates, job openings, events, or other workforce or job-related information. Each client application 153 may be associated or accessed by a particular user or user group, such as a government agency, a local employer, an education institution, or an individual candidate.

Memory module 112 of the computer system 106 may be any form of non-transitory computer-readable media, including, but not limited to, dynamic random access memory (DRAM), static random access memory (SRAM), Erasable Programmable Read-Only Memory (EPROM), Electrically Erasable Programmable Read-Only Memory (EEPROM), flash memory devices, magnetic disks, internal hard disks, removable disks, magneto-optical disks, Compact Disc Read-Only Memory (CD-ROM), any other volatile or non-volatile memory, or a combination thereof. Memory module 112 serves to store machine-executable instructions, data, and various software components for implementing the techniques described herein, all of which may be processed by CPU 110. As such, the computer system 106 is a general-purpose computer system that becomes a specific-purpose computer system when executing the machine-executable instructions. Alternatively, the various techniques described herein may be implemented as part of a software product. Each computer program may be implemented in a high-level procedural or object-oriented programming language (e.g., C, C++, Java, JavaScript, Advanced Business Application Programming (ABAP™) from SAP® AG, Structured Query Language (SQL), etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

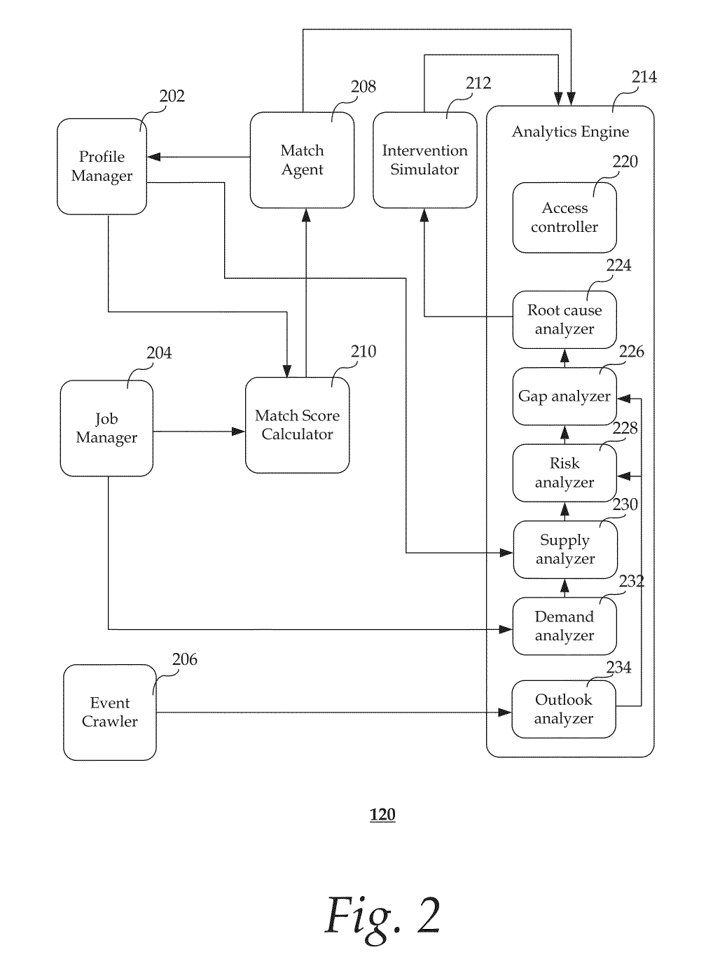

In some implementations, memory module 112 of the computer system 106 includes a predictive workforce planning and analytics engine 120 for implementing the techniques described herein. FIG. 2 shows exemplary components of the predictive workforce planning and analytics engine 120. Predictive workforce planning and analytics engine 120 may include, but is not limited to, a profile manager 202, a job manager 204, an event crawler 206, a match agent 208, a match score calculator 210, an intervention simulator 212 and an analytics engine 214. It should be appreciated that some or all of these components may also be implemented in another computing system.

Generally, profile manager 202 serves to capture, manage and/or present the profile data of individual candidates. Profile manager 202 may provide functions to, for example, submit, import and/or edit profile data, invite other people to rate the profiles, etc. Job manager 204 serves to capture, manage and/or present job data of available job openings. Event crawler 206 serves to discover and/or manage event data or information that is related to workforce-related events from various data sources.

Match score calculator 210 serves to generate a match score based on the job data and the profile data of each candidate. The match score may indicate the level of compatibility between an individual candidate's profile features with job requirements. In some implementations, the match score is provided to the match agent 208 to identify skills that need to be acquired or updated (e.g., unmet skills with match scores less than a predetermined threshold) in order to improve the match score. Match agent 208 then communicates the unmet skills and match score to the profile manager 202 to inform the user (e.g., individual candidate, training organization, etc.) or to the analytics engine 214 to perform further analytics. For example, a match score of 80 (out of 100) and a list of unmet skills will provide a fuller picture of an individual's competency. Based on such information, individual candidates may seek to improve or acquire such unmet skills by, for example, enrolling in relevant educational programs or activities. Education institutions may also use this information to provide relevant educational programs or activities to fulfill the demand for such unmet skills.

Analytics engine 214 may include access controller 220, root cause analyzer 224, gap analyzer 226, risk analyzer 228, supply analyzer 230, demand analyzer 232 and outlook analyzer 234. Access controller 220 serves to manage the access controls of the different analyzers 224-234. More particularly, access controller 220 may limit the access of the different analyzers 224-234 by different groups of users, such as individual candidates, educational institutions, government and local employers. For instance, access controller 220 may authorize individual candidates to access results generated by gap analyzer 226, risk analyzer 228, demand analyzer 232 and outlook analyzer 234. Educational institutions may be authorized to access results generated by gap analyzer 226, while employers may be authorized to access results generated by the gap analyzer 226, supply analyzer 230 and demand analyzer 232. The government may be authorized to access results or reports generated by the root cause analyzer 224, gap analyzer 226, supply analyzer 230, demand analyzer 232 and outlook analyzer 234.

Demand analyzer 232 may serve to generate a demand report indicating the skills that are currently in demand by the employers. Supply analyzer 230 may further serve to generate a supply report indicating the skills that are currently supplied by available candidates. Outlook analyzer 234 may serve to generate a report indicating a forecast of skills that may be in demand by employers in future. Risk analyzer 228 may serve to generate a report indicating a risk level of unemployment. Gap analyzer 226 may further serve to generate a gap report that identifies differences between current skill sets provided by candidates and skill sets desired by employers. In addition, root cause analyzer 224 may serve to determine the root cause of mismatches between supply and demand for jobs. It should be appreciated that the individual reports generated by, for example, the root cause analyzer 224, gap analyzer 226, supply analyzer 230, demand analyzer 232 and/or outlook analyzer 234 may be integrated into one or more reports.

The intervention simulator 212 may serve to reproduce the operation or behavior of the job market under the influence of one or more intervention options. An intervention option generally refers to any strategy, event, plan, step, policy, etc. that is designed to have an impact on the outlook, demand and/or supply of jobs. Such intervention option may be identified manually, semi-automatically or automatically.

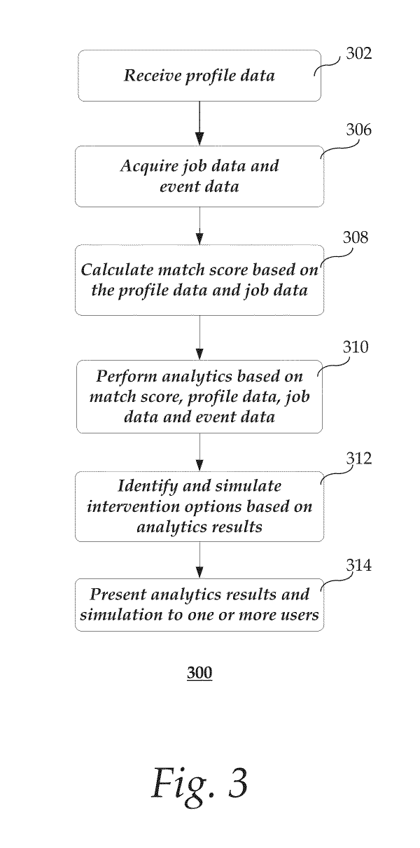

FIG. 3 shows an exemplary method 300 of predictive workforce planning and analytics. The method 300 may be performed automatically or semi-automatically by the computer system 106, as previously described with reference to FIGS. 1 and 2. It should be noted that in the following discussion, reference will be made, using like numerals, to the features described in FIGS. 1 and 2.

At 302, the profile manager 202 receives profile data of one or more job candidates. Profile manager 202 may obtain the profile data directly input by a user of the client device 152 via client application 153, or by search agents automatically crawling an external data source 118, such as a professional social network (e.g., LinkedIn+), etc. Search agents may include pre-defined search criteria (e.g., “Location=Singapore, Job Title=Junior Software Engineer”) by which the searches may be based. The search agents may automatically perform the searches periodically or at regular intervals (e.g., daily, weekly, monthly, etc.) to acquire profile data of multiple job candidates.

Profile data of a job candidate may include profile features such as a user identifier (ID), acquired qualifications (e.g., degrees, certifications, etc.), acquired skills (e.g., computer languages, languages, etc.), personal data (e.g., alias, age, gender, address of residence, years of working experience, previous employers, etc.), development needs, search agents, rankings, and so forth. “Rankings” may include normalized rankings (or levels) of acquired skill competencies based on peer review. For example, a job candidate Bob may have the skill “Java script programming”. He may rank his own skill competency as 4 out of 5, which is a highly subjective approach. A more objective alternative approach is to invite his peers to rank his skill competency. The profile manager 202 may consolidate all the rankings (or reviews) from Bob's peers by computing an average ranking. The average ranking may then be normalized to a specific range (e.g., 1-5). For example, Bob's normalized ranking may be 3.4 for his “Java script programming” skill.

At 306, job data and event data are acquired. Job data of each job opening may include information such as, for example, a job ID, required skills (e.g., skill description, alias, years of experience, skill level, necessity level search agent, etc.), job title, time stamp, etc. In some implementations, the job manager 204 automatically discovers job data of multiple job openings by crawling one or more data sources 118, such as job portals, employers' websites, recruitment agencies' websites, etc. The job manager 204 may discover job data by performing searches using one or more pre-defined key words that are related to job openings (e.g., skill descriptions). Additionally, or alternatively, the job manager 204 may acquire the job data directly from user input via client application 153.

In some implementations, event crawler 206 automatically discovers event data by crawling one or more data sources 118. Exemplary data sources that provide event data include, but are not limited to, news feeds, online publications of economic outlook, business environment, company strategies and/or technological trends, employer websites, online magazines, journals, etc.

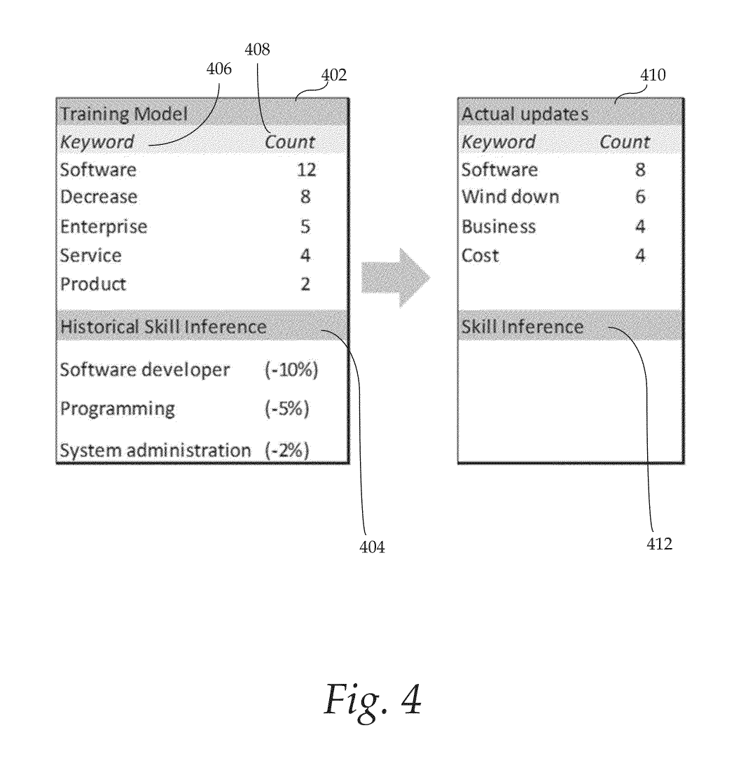

In some implementations, event data is associated with skill-related events, which are detected when a non-empty skill inference can be made after parsing data from the one or more data sources 118. Event data may be specific to a particular industry, economy, policy, technology, and so forth. FIG. 4 illustrates an exemplary method of deriving skill inferences. A training model 402 may be generated by applying a machine learning algorithm (e.g., support vector machine, etc.) on training data to identify historical skill inferences 404 from past text reports. The training data may include multiple keywords 406 and the number of times each keyword appears in the training data may be stored as a count 408. The training model 402 may then be applied on actual update information 410 retrieved from the data sources 118 during run-time to derive new skill inferences 412. A skill-related event may be stored in memory using the following exemplary format: (keyword1, keyword2, etc., source key, industry key, company key, technology key, sentiment key, sentiment score, skill key(s), inference score(s)). The event crawler 206 may perform regression analysis based on historical event data to forecast the developing trends, such as the quantity of candidates required to fulfill the demand for particular skills or qualifications.

At 308, the match score calculator 210 computes the match score between each candidate and each available job opening based on the profile data and the job data. The match score may be computed by, for example, determining the number of matches between the list of skills in the profile data of a candidate with the list of required skills in a job opening, and computing the match score based on the number of matches. For instance, a candidate named Bob has acquired 7 skills in his profile. The names (or aliases of the names) of 5 of these 7 skills may match the names of 5 out of 10 required skills of a job opening. Assuming that all required skills have the same weights, the matching score may be (5/10)*(5/7)=0.36.

In some implementations, different types of weighing factors may be assigned in computing the match score. One type of weighing factors includes importance weighing factors. Importance weighing factors may be assigned to matching and required skills in the job opening. The values of the importance weighing factors may be determined based on the listing order of required skills in the job opening. This is based on the assumption that more important skills are typically listed first in job listing. Accordingly, the required skill listed first in the sequence is assigned an importance weighing factor of 1, while the last listed required skill is assigned the importance weighing factor of 0.5, and those skills in between the first and last skills may be linearly distributed. Another type of weighing factors includes competency weighing factors. Competency weighing factors may be assigned to matching and acquired skills of the job candidate. The values of such competency weight factors may be determined based on the normalized rankings of individual acquired skills.

The final match score may be computed as follows:

Match_score={Sum of (importance_weighing_factor) of matching skill i/Sum of (importance_weighing_factor) of required skill i}*{Sum of (competency_weighing_factor) of matching skill j/Sum of (competency_weighing_factor) of acquired skill j1},(1)

wherein i={1, 2, . . . , N} and j={1, 2, . . . , M}, N is the number of required skills and M is the number of acquired skills.

The match agent 208 then receives the match score from the match score calculator 210. The match agent 208 may identify skills that need to be acquired or updated (i.e. unmet skills) in order to improve the match score of the corresponding candidate. More particularly, the set of unmet skills are those required skills of job openings that do not match any of the candidate's acquired skills. Each unmet skill may be associated with the skill importance weighing factor. It should be noted that if the match score is less than a predetermined value (e.g., 0.2), the “unmet skills” may not be saved. The set of unmet skills may grow as the number of job openings increase. The final set of unmet skills may be sorted by, for instance, {Sum of (importance_weighing_factor) of unmet skill of job_i, wherein i=1, 2, . . . } in descending order and reported to the individual job candidate.

At 310, the analytics engine 214 may perform analytics based on the match score, profile data, job data and event data. In some implementations, such analytics include outlook forecast, demand analytics, supply analytics, risk analytics, gap analytics and/or root cause analytics. The analytics may be performed in substantial real-time.

Demand analyzer 232 may be employed to generate a demand report that indicates the skills that are currently in demand by employers. To identify such skills, the demand analyzer 232 may analyze the job data of available job openings provided by the job manager 204. In some implementations, each job opening is associated with a set of required skills. The demand analyzer 232 may aggregate the required skills of the job openings and sort them according to, for example, user-defined categories (e.g., by industry, city, etc.). The skills that occur more frequently in the job data may be indicative of higher demand for those skills. A filter may be implemented to remove duplicate job openings.

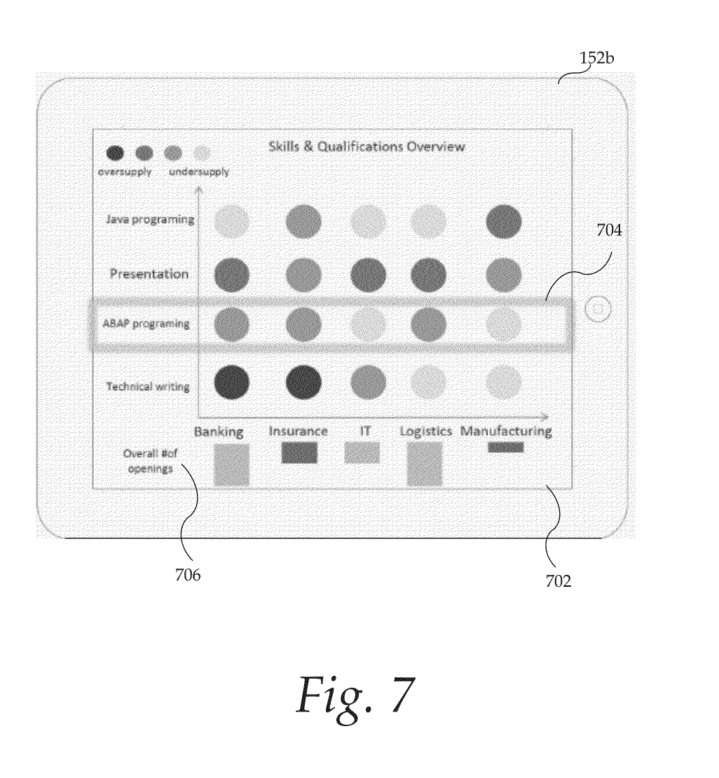

Supply analyzer 230 may further be employed to generate a supply report indicating the skills that are currently supplied by job candidates. Such supply report may be generated based on the profile data provided by the profile manager 202. In some implementations, each individual profile is associated with a set of profile features, including a set of acquired skills. The supply analyzer 230 may aggregate the acquired skills of the individual profiles of candidates in the profile data, and sort them according to, for example, user-defined categories (e.g., by industry, city, etc.). The acquired skills that occur more frequently in the profile data may be indicative of higher supply for those skills. In some implementations, the supply and demand reports are integrated into one report or dashboard, as will be described in more detail with reference to FIG. 7.

Outlook analyzer 234 may be invoked to generate an outlook report that predicts a set of skills that are likely to be in demand by employers in future. The forecast may be determined based on the event data provided by event crawler 206. For example, machine-learning techniques may be performed to identify developing trends and desired skills that appear frequently in the event data. In some implementations, an article in the event data is classified into pre-defined categories (e.g., “information technology”, “performance”, “meet expectations”, etc.). Exemplary machine-learning techniques include, but are not limited to, classification and/or clustering performed based on word counting and text categorization using support vector machines (SVM).

Risk analyzer 228 may be used to generate a risk report indicating a risk level of unemployment. In some implementations, the report is generated based on an individual candidate's profile and accessible only to that particular individual candidate due to data sensitivity concerns. The risk analyzer 228 may compare the acquired skills of the candidate with the skills that may be in demand in future as indicated by, for example, the outlook report, to determine an outlook score. Least matched candidates with a relatively low match score (indicative of current demand) and negative outlook score (indicative of future demand) may see, for example, a warning indicator associated with a high risk level (i.e. greater than a predetermined warning threshold). The candidate may pre-set his or her own warning threshold.

Gap analyzer 226 may be used to generate a gap report. The gap report may be determined based on, for example, the demand report, the supply report and the outlook report. The gap report may identify one or more skills desired by employers in the future market listed in, for example, the outlook report, that are least fulfilled by the job candidates in the current market.

For instance, assume there is a total of 100 skills. Each skill may be associated with a gap indicator including the following 2 components: (1) number of jobs in demand per job opening in the current market divided by number of jobs available per candidate in the current market, and (2) number of jobs in demand per job opening in the future market divided by number of jobs available per candidate in the future market. Skills with lower ranked gap indicators (i.e. least fulfilled skills) may be indicated in the gap report generated by gap analyzer 226.

Root cause analyzer 224 may further be used to determine the root cause of mismatches of supply and demand for jobs. A root cause report may be generated based on the gap report from the gap analyzer 226 and a list of least matched users from risk analyzer 228. Root cause analyzer 224 may generate, for example, a report indicating the breakdown of candidate profile features and events that constitute the root cause of the mismatches (or low match scores) between acquired skills of job candidates and required skills listed in job openings. For instance, common profile features (e.g., age group, education level, etc.) may be identified from the list of least matched users. Common event triggers, such as factory shutdown, policy announcement, etc. may also be identified from the root cause report.

At 312, one or more intervention options are identified based on the analytics results. The intervention options may be identified manually, semi-automatically or automatically. The intervention simulator 212 may then be invoked to reproduce the behavior of the job market driven by the job data (i.e. demand data) and the profile data (i.e. supply data) under the influence of such intervention options. The simulation of the job market allows the user to evaluate the effectiveness of such intervention options before they are implemented.

In some implementations, the intervention simulator 212 includes a sandbox system that provides the environment to perform the intervention option before its actual realization. The sandbox system may be executed in parallel with the run-time system. In some implementations, the intervention simulator 212 communicates only to the sandbox system, while the analyzers 224-234 communicate both to the sandbox system and the run-time system. The sandbox system may serve to enable authorized users to change and/or create intervention options that have an impact on the outlook, demand and/or supply of jobs. The effects of such manually created intervention options may be analyzed and reported by the analyzers 224-234, but not stored. The sandbox system may be re-synchronized with the run-time system once the analyses on the intervention options are completed.

At 314, the results of the analytics and simulation are presented to one or more users or user groups. Different users may be authorized to access different analytics results and personalized content via the client device 152. Such authorizations may be managed by, for example, access controller 220.

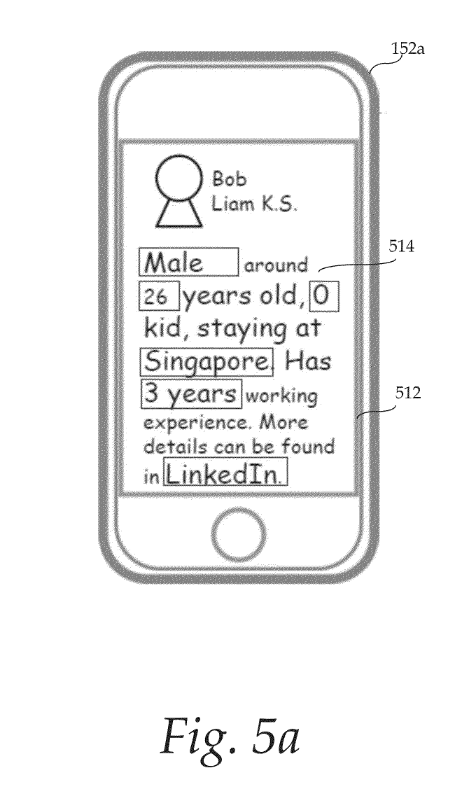

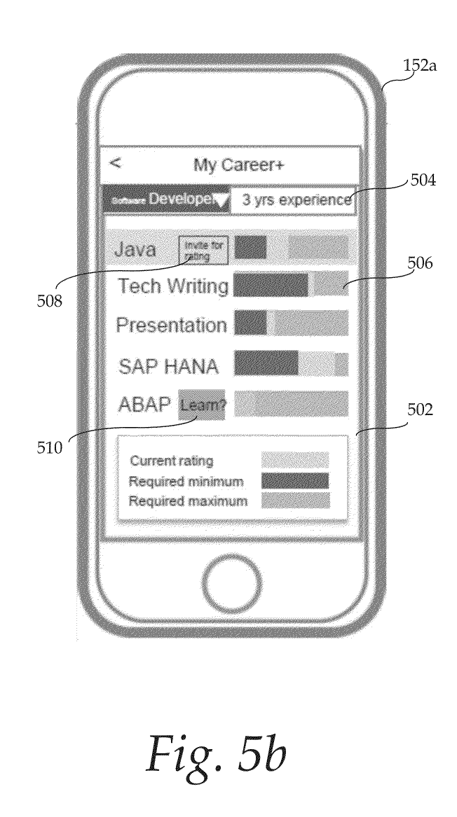

FIGS. 5a-b, 6 and 7 illustrate exemplary dashboards presented by client application 153 based on the predictive workforce planning and analytics framework described herein. More particularly, FIG. 5a shows an exemplary dashboard 512 presented by client application 153a at client device 152a. The user may be an individual candidate or job seeker. As shown, the dashboard 512 may present a description 514 of the user's profile data (e.g., current skills, career status, personal information, etc.). The user may interact with the dashboard 512 to update or keep track of his or her current profile data.

FIG. 5b shows another exemplary dashboard 502 presented by client application 153a at client device 152a. The user may interact with the dashboard 502 to import and/or maintain job data, such as job status 504 and skill sets with normalized ratings 506. The user may select a specific skill 508 and invite other users to rate the skill. The client application 153a may also present a reminder 510 to suggest to the user to upgrade or learn other skills commonly required by job openings related to the user's profile.

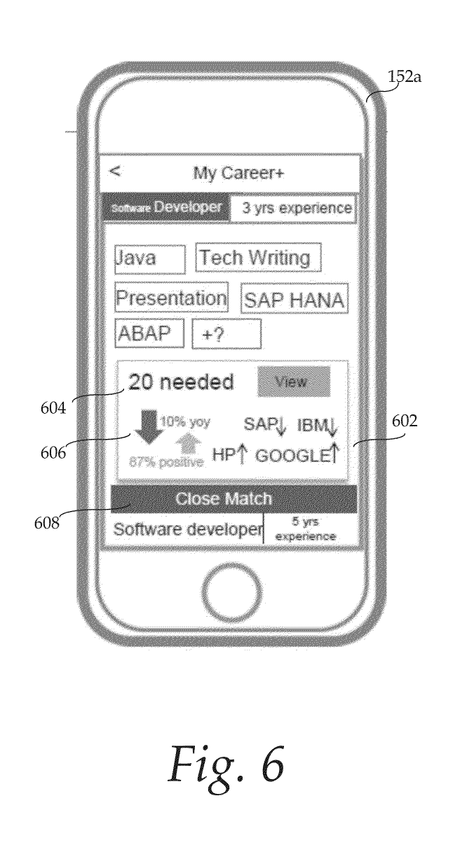

FIG. 6 shows another exemplary dashboard 602 presented by client application 153a at client device 152a. The dashboard 602 may inform the user of the current job market demand 604, the developing trend and/or outlook 606 based on the user's profile data maintained by the client application 153a. The dashboard 602 may also recommend a close match profile 608 that has a larger market demand.

FIG. 7 shows an exemplary report 702 presented by client application 153b at client device 152b. The user may be a government agency, a local employer, an educational institution or an individual candidate. The report 702 summarizes analytics results that show the gap between supply and demand 704 for particular skills. The dashboard 702 may further show the demand for jobs 706 in particular industries. Other types of analytics results may also be presented by the report 702.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A method of workforce planning, comprising:
automatically acquiring, by a processor, profile data of multiple job candidates, job data of multiple job openings and event data;
automatically generating, by the processor, an outlook report based on the event data, wherein the outlook report predicts a set of skills that are likely to be in demand by employers in future; and
automatically generating, by the processor, a gap report based on the profile data, the job data and the outlook report, wherein the gap report identifies one or more skills from the predicted set of skills that are least fulfilled by the job candidates.

2. A method of workforce planning, comprising:
receiving profile data of at least one job candidate and job data of at least one job opening from multiple data sources;
automatically determining, by a processor, a match score between the job candidate and the job opening;
automatically performing, by the processor, analytics based at least in part on the match score, the profile data and the job data; and
presenting, by the processor, results of the analytics.

3. The method of claim 2 further comprising automatically acquiring the profile data by crawling at least one of the multiple data sources.

4. The method of claim 2 further comprising automatically acquiring the job data by crawling at least one of the multiple data sources.

5. The method of claim 2 wherein determining the match score between the job candidate and the job opening comprises:
determining a number of matches between acquired skills in the profile data of the job candidate with required skills in the job data of the job opening; and
computing the match score based on the number of matches.

6. The method of claim 5 wherein computing the match score comprises assigning importance weighing factors to matching skills and the required skills of the job opening.

7. The method of claim 6 further comprising determining values of the importance weighing factors based on the listing order of the required skills in the job opening.

8. The method of claim 5 wherein computing the match score comprises assigning competency weighing factors to matching skills and the acquired skills of the job candidate.

9. The method of claim 5 further comprising:
identifying a set of unmet skills in the job data of multiple job openings that do not match any acquired skill in the profile data; and
reporting the set of unmet skills to the job candidate.

10. The method of claim 2 wherein automatically performing the analytics comprises generating a demand report that indicates skills currently in demand by employers by aggregating required skills of job openings in the job data.

11. The method of claim 2 wherein automatically performing the analytics comprises generating a supply report that indicates skills currently supplied by job candidates by aggregating acquired skills of multiple job candidates in the profile data.

12. The method of claim 2 further comprising automatically discovering event data from a data source by crawling a data source and performing the analytics based on the event data.

13. The method of claim 12 wherein automatically discovering the event data comprises using a training model to derive skill inferences from data retrieved from the data source.

14. The method of claim 12 wherein automatically performing the analytics comprises generating an outlook report based on the event data, wherein the outlook report predicts skills that may be in demand by employers in future.

15. The method of claim 2 wherein automatically performing the analytics comprises generating a risk report that indicates a risk level of unemployment of the job candidate.

16. The method of claim 2 wherein automatically performing the analytics comprises generating a gap report.

17. The method of claim 2 wherein automatically performing the analytics comprises generating a root cause report that indicates a root cause of a mismatch between acquired skills of multiple job candidates and required skills of job openings.

18. The method of claim 2 further comprising simulating a job market driven by the profile data and the job data under the influence of one or more intervention options.

19. A non-transitory computer-readable medium having stored thereon program code, the program code executable by a computer to:
receive profile data of at least one job candidate and job data of at least one job opening from multiple data sources;
automatically determine a match score between the job candidate and the job opening;
automatically perform analytics based at least in part on the match score, the profile data and the job data; and
present results of the analytics.

20. A system comprising:
a non-transitory memory device for storing computer readable program code; and
a processor in communication with the memory device, the processor being operative with the computer readable program code to
receive profile data of at least one job candidate and job data of at least one job opening from multiple data sources,
automatically determine a match score between the job candidate and the job opening,
automatically perform analytics based at least in part on the match score, the profile data and the job data, and
present results of the analytics.
